(19) United States
(12) Patent Application Publication
(10) Pub. No.: US 2020/0009857 A1
(43) Pub. Date: Jan. 9, 2020

(54) Digital full-color 3-dimensional stamped metal

(71) Applicant: Glen G. Bries, Green Bay, WI (US)

(72) Inventor: Glen G. Bries, Green Bay, WI (US)

(21) Appl. No.: 15/998,120

(22) Filed: Jul. 3, 2018

(51) Int. Cl. B41F 19/02; B41M 1/22

(52) U.S. Cl. CPC B41F 19/02; B41M 1/22

(57) ABSTRACT

Sublimation (transfer of color via existing heat activated process) of computer generated process color/full color images into polyester coating that has been applied to the flat surface of malleable metal. A dimensional metal stamping die is then created with relief and/or texture to correspond in location to or otherwise enhance the color image that has been previously sublimated on the flat metal. Metal is then locked into position and stamped with the impression that has been cut into the hardened die. The result is a new, efficient method to achieve life-like color on 3-dimensional sculpted metal. Virtual patinas and tinting can also be achieved without additional chemicals or plating. Digitally generated variable printed data, variable sublimated color images and variable color schemes can be sublimated before minting or added as a third step with good definition on raised flat areas post stamping.

### TECHNICAL FIELD

Metal decoration and enhancement colorization printing using digitally generated dye sublimation (heat transfer of color) into flexible full-surface polyester based coating on metal, combined with stamping or minting.

### BACKGROUND

Metal has long been a prestige item due to its durability, its weight, its varied but distinguishable appearances and even its sound! Adding dimensionality and sculpture-based stamped or minted detail further enhances the perceived value of the images that metal conveys. While technology and the styles that it inspires thru the use of color, photography, video and even 3d printing continue to advance, metal still holds its place in most cultures as an image enhancer. Unfortunately, physical realities and previous technological limitations have made it expensive and difficult to manufacture dimensionally-stamped metal with realistic full colorization. Efforts to add color after the forming of dimensional metal jewelry, medallions and other decorative and promotional products have been on-going since (probably) the beginning of metal shaping with the use of spot paints, patinas, jewels, screen printing, coatings, plating, enamel fill, cloisonne' etc. Adhesion has always been an issue and pre-form painting/inking with the use of surface paints/inks has been expensive, messy and limited in success. One of the best attributes of metal is that you can scrape patches of most other substances off of it, including paint. Therefore, adding durable tints or color to the face of metal has often been most successful when approached as an “all or nothing” proposition, with coatings such as lacquers, plating and powder coatings typically covering metal's total exposed surface.

As a step forward in the quest to combine color (including full photographic) and sculptural dimension on metal, I have reversed the most common approach to enhancing metal. Most often the process is to “mint (die stamp) the sculpted detail, then coat/decorate (add color/tint). By using the sublimation process for colorization instead of screen printing, direct printing, stenciling, etc., I was able to take advantage of the facts that modern polyester coatings (1) accept sublimation (2) can be quite flexible so the coating and the sublimated color within it stretch with the metal surface when stamped. (3)can be clear or white, which allows for colors or the metal itself to be nicely displayed. (4)are applied via an “all or nothing/full coverage is best” (ideal) process for coating metal surfaces. (are not applied as spot colors/not as vulnerable as most spot colors to chipping off, especially during forming.) (5) adhere well to the metal. 6) protect and preserve the desired patina of the metal while allowing the metal to be seen. All of these factors contribute to the fact that sublimated color metal can effectively be stamped post-coat/decorate and remain durable as a finished dimensional/color product. Sublimation also has many well documented advantages over other processes and those can now be applied to products that have been minted due to this new approach.

The initial seed for my invention, Digital full-color 3 dimensional stamped metal came when I—out of sheer curiosity—placed a piece of black coated brass engraving stock I had in my hand at the end of a long day on top of a medallion that was still in the die on the press and pushed the button to “mint” (stamp/form) the image into the plate. I was surprised to find that the black paint/engravable coating on engraving stock held up better than expected when stamped. The crisp fine detail stamped from the (existing) medallion stamping die that I minted the piece under did not cut thru or tear the surface of the black coating. In itself, this could be considered a useful discovery but it is not this invention. That came later when I combined this discovery with (1) prior knowledge of the sublimation process, (2) critical thinking that lead me to (3) think backwards (when compared to the traditional thinking about colorizing fully contoured/textured minted coins), (4) verification testing of theory to develop process steps, (5) research of coatings and metal alloys that are both sublimatable and flexible enough to be minted, and finally (6) production of prototypes.
1) Prior Knowledge: As a Purchasing Manager with prior experience in the awards/promotional products decorating business, I had brought sublimation into the mint I worked for to print flat plates for plaques and bases that displayed the medals. From experience working for companies prior to the mint, I know that sublimation transfers color into (not on top of) “sublimatable” coatings, has only computer graphics based job/image specific setups, is digitally generated, is full process color, utilizes low cost equipment (less than $5000.00), requires little special technical skill or training to execute, makes product quickly, allows for variable data very efficiently, and deposits color into full coverage coating which often translates to better adhesion than other “spot/color on top of the surface” processes for printing on metal. (I wish I had invented the sublimation printing process, but sublimation itself not this invention.)
2) Critical Thinking: While the sublimation equipment still sat idle at the mint, even for printing on flat metal award plates, more expensive direct print Mimaki and Roland processes are being used (despite frustrating adhesion to metal problems). Mimaki/Roland direct-print were also used to print in recesses on medals, but again, adhesion is poor and the printed cavities had to be filled with clear/thick epoxy to hold the color in. I began thinking about sublimation. I knew that on flat metal printed plates, the color in sublimation is more durable than most “on top of the surface printed or colorizing” processes because it is in the “full coverage” coating, and not adhered to the surface in only certain spots. Unfortunately, for stamped/sculptural items, sublimation wouldn't work because it transfers color as a gas from flat printed paper transfer sheets to flat metal, and gaps between the flat paper that carries the color and the stamped/non-flat item allow the color in its gaseous state to drift before penetrating the metal coating, which creates blurry definition. Then I remembered the time that the full-faced engravable black paint coating on the engravable brass sheet I had stamped had endured the being die stuck (minted).
3) Thinking Backwards: That's when the invention became a theory in my brain that by using flexible, full-surface colorized coating it should be possible to get better results than had been previously achieved (applying color in spots that are not part of/do not stretch with the entire surface of the metal/metal coating) when reversing the traditional order of processes.
   c) Minting of dimension and texture traditionally stamp first, then decorate/apply finishes/textures, then plate, paint, color-fill, antique, relieve or otherwise decorate the stamped piece. Why not stamp after color?
   b) Traditionally, the application of color onto the surface in spots, creating artistic and durability limitations. Why not apply the color into the full coverage surface coating rather than in spots on the surface.
   a) Traditionally, Patinas, metallic tints or plating and variable print images/data are added after minting. Why not decorate with those features prior to stamping via digital sublimation to create endless possibilities for 3d colorization with no mechanical setups. Only changes to the computer generated color images should be required. And, it's full process color to allow for a photographic look!
4) Verification/Testing: I now felt I had the makings of an invention that was worth proving out. I stamped a few pieces of clear coated sublimation aluminum and brass sheet and then tried to chemically oxidize the brass and aluminum underneath the coating after stamping, so I was quote certain that there were coatings that could be both (first) sublimated, and (second) minted/die stamped.
5) Research: I then researched coatings that accept sublimation/gaseous color transfer and found that they must be polyester based, and that polyester-based coatings can have characteristics in terms of (1) accepting gaseous color transfer (sublimatability) (2) flexibility and (3) adhesion to the alloy being stamped. Knowledge of metal alloy softness for stamping can be looked up on easily on the internet.
6) Production of Prototypes: I “sublimated” color images into both prefinished/pre-coated sublimatable sheet stock that is readily available on the market as well as onto thicker parts sprayed with polyester based coatings, then stamped with good success. See product images (FIG. 2 and FIG. 4) to this patent application). Copper based, aluminum based and zinc based alloys have all been printed then minted with this process and this patent can logically be applied to any mintable alloy to which well-chosen polyester based coatings can be applied with good adhesion, including but not limited to pewters, gold and gold alloys, silver and silver alloys, aluminum and aluminum alloys, copper and copper based alloys, iron, mild steel, palladium and many others

### SUMMARY

This invention requires full-faced malleable polyester coating on malleable flat metal→then sublimation colorization of computer/digitally generated images into that polyester coating→then stamping/forming of that face of the metal using a sculpted, hardened, dimensional metal stamping die so that the sublimated image stretches and corresponds to or enhances the dimensional stamping. This specific order of process steps, use of material families (malleable polyester coatings and metals), and processes (sublimation printing on flat metal, then stamping/forming) advances (1) the use of spot colors and/or photographic full color and/or (2) variable imagery, and/or (3) visual enhancement of stamped finish/texture, and/or (4) tint/patina alteration and (5) durability enhancement and (6) reduction of coating layers to one layer in the production of dimensionally stamped sculpt and/or texture in metal product surfaces including but not limited to: jewelry, medallions, coins, signage, name badges, product labels, art reproduction, signage, home decor, faux surfaces/finishes, and decoration or enhancement of any kind.

Taking advantage—in the correct process order, and for the desired results listed in the claims of this patent—of the unique combination of characteristics of polyester coatings applied to the full face of flat metal before sublimating and stamping, to efficiently achieve durable color, tint and shading that can, but does not have to be variable from one part to the next in stamped/dimensional metal surfaces is the basis of this invention. That unique combination characteristics that exist in polyester coatings for this process includes:
1) Strong adhesion to metal—especially when applied to the full surface—that is stronger than the elastic properties of the polyester itself. This allows the coatings to remain in place in relation to the metal under them when stamped.
2) The malleability to stretch when stamped. (not all polyester coatings are the same in this regard, as some are more brittle and some are more malleable).
3) Acceptance of dye for colorization into (not just on the surface of) the polyester coating for enhanced durability of colorization when compared to many spot application of color(s) on metal surfaces.
4) Coating can be clear or white so that when colorized via the sublimation process, the result is either opaque color when white coating is used, or translucent coating when clear coating is used. When the coating is clear, the metal's reflectivity, finish and hue can be seen through the applied color allowing it to remain fully exposed, tinted or densely colored throughout the stamped/dimensional surface.
5) Protective coating and full photographic colorization on dimensionally stamped metal surfaces can be applied as/to a single layer.

### BRIEF DESCRIPTION OF THE DRAWINGS

The drawings and images included detail the process steps and examples of its results. The drawings are to describe but not show or limit the specific equipment used to execute the process and illustrate/ship examples of but not all actual product that can be produced via this process. Existing knowledge product-results-impactors including but not limited to metal finishing processes and equipment, alloys, hardness, sublimation and stamping equipment types and brands, polyester coating types and application techniques, and others are not addressed within these drawings.

The patent or application file contains at least one drawing executed in color. Copies of this patent or patent application publication with color drawing(s) will be provided by the Office upon request and payment of the necessary fee 37 CFR 1.117(h). As a utility patent (not a design patent), these images demonstrate process results and products can be produced in many variations not limited to the color image included.

FIGS. 1(A, B & C) flow charts the process

FIG. 2 demonstrates the variable versions of product that can be produced with excellent efficiency as one offs, in small color-scheme based batches, or in large quantities with one color-scheme by simply changing metals, and/or changing metal finish and/or changing coating color from white to clear (or vice-versa) and/or altering the print image using computer generated color graphic design.

FIG. 3 is a generic representation of the basic equipment and materials used in the process.

FIG. 4 shows visual alteration of stamped metal images using this process that can be realistic in full color and/or accentuate, capitalize on, or alter the unique visual characteristics of metal in ways that are both variable and (cost) efficiently achieved.

### DETAILED DESCRIPTION

All terminology, phrasing and word choices in these description details are to be considered in conjunction with the drawings and images, and in the context of the following categories of existing knowledge: Metal die-stamping. Sublimation/heat transfer colorization on Metal. Metal coatings.

Beyond those categories of existing knowledge, all information is meant to be understood by the general public and should be interpreted with this in mind so that the most obvious layman's understanding is applied. To avoid confusion between Sublimating (colorizing) and Metal Stamping, which both use machines called a “press”, the mechanism that creates the heat and pressure needed to transfer color from printed paper into polyester coating on metal will be referred to as “Sublimator” in this documentation because it does not create a dimensional change in the part being created. Therefore all references to a “press” refer to a metal die stamping press, which uses weight/pressure to stamp the dies image into the part.

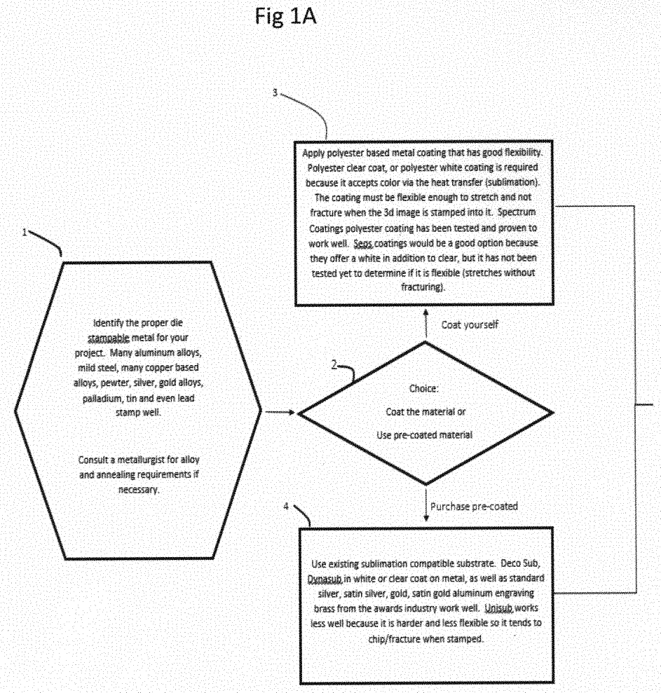

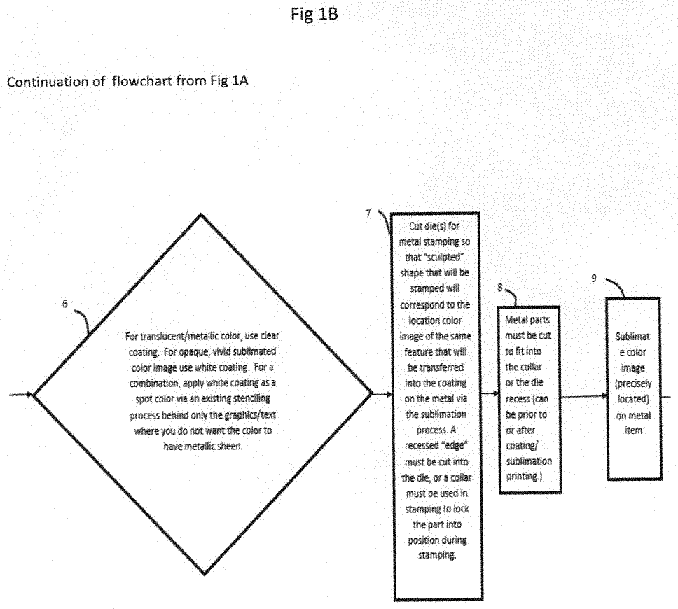

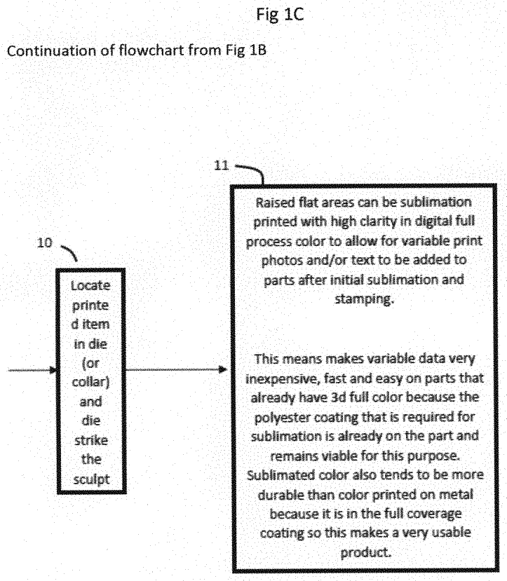

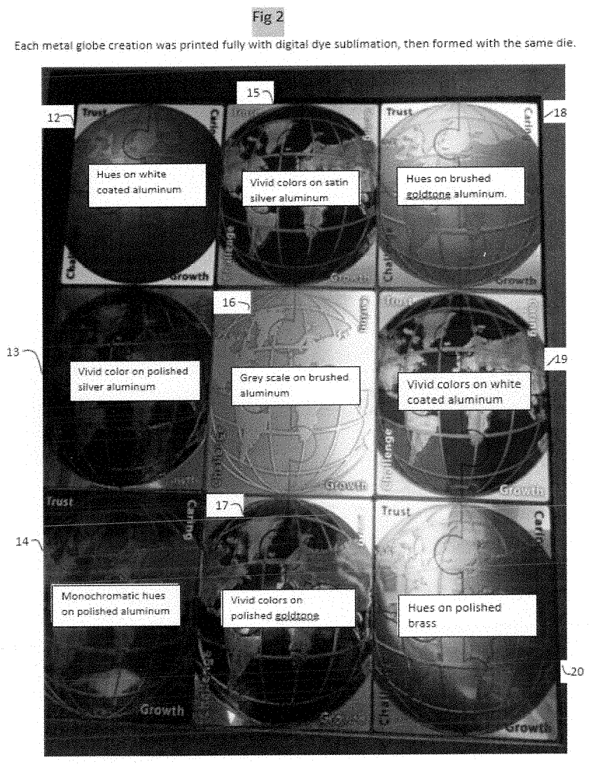

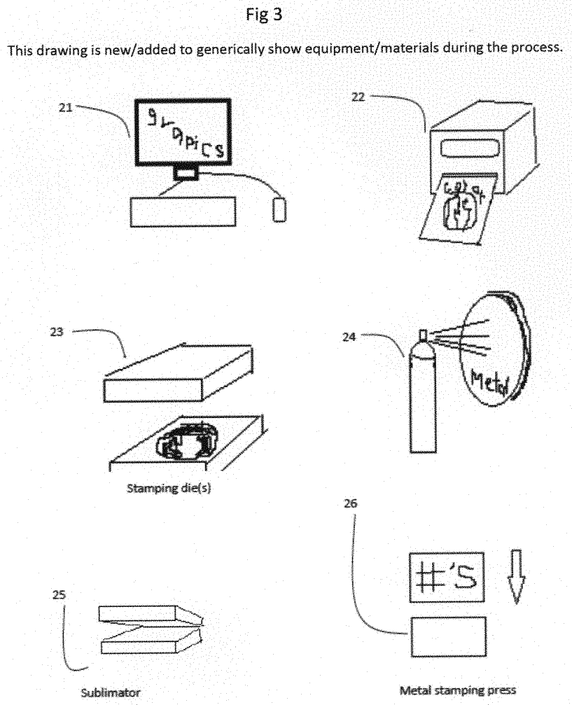

FIG. 1A, 1B, 1C and FIG. 3 show materials used: malleable metal alloys 1, to be coated with malleable, sublimation-accepting polyester 3 24 coating that is clear or white 6 24 , or pre-coated with malleable, sublimation-accepting polyester 4 24 coating that is clear or white 4 24 for the same result of malleable sublimation accepting coating on malleable metal 3 4 6 24.

FIG. 1A, 1B, 1C shows the order of steps. Appropriate alloy of flat-faced stamping-friendly metal is chosen 1. Decide 2 to apply full-face polyester coating on flat-faced metal 3 or select existing polyester coated metal 4 that has been proven to work. Choose 5 white polyester coating for opaque, vivid color and shading or clear polyester coating for metallized translucent color, effects, tinting, shading and patinas. Creation of digital color art file 6 and cutting the stamping die 7 must be sequential, and either can come first but the second in the sequence must be created to correspond in location/position with the first so that it is positioned as intended to colorize/add shape or texture to, or otherwise enhance the first. The digital art file is then printed 8 on paper using a typical printer that is loaded with sublimation toner. The printed image on the paper is then precisely aligned with the flat metal part so that the printed side of the paper and the polyester coated face of the metal part are face to face so the color image can be sublimated 9 (heat and pressure transferred) from the paper into the polyester coating. The (now colorized) flat part is then removed from the sublimator and allowed to cool. The hardened metal stamping die is then loaded into the press and the colorized part is positioned under it and locked into position 10. The dimensional image is then stamped into the part 11.

FIG. 2 demonstrates some of the many versions of colorization, tints, effects and patinas that can be achieved without adding production steps. The items stamped with the same dimensional die 12 13 14 15 16 17 18 19 20 can result in many different appearances via choices in metal and/or coating color, and on-computer alterations to digital art color scheme for output on flat paper. These different appearances include, but are not limited to: endless but not metallic vivid colors, hues and shading on material coated with white polyester 12, reflective metallic color and exposed plain metal on polished aluminum 13, monochromatic reflective tone on tone with exposed metal areas on polished aluminum 14, Vivid colors with less reflective metal influence on clear coated satin finish silver aluminum 15, translucent grey to create the impression of antique/oxidation on brushed aluminum 16, rich vivid reflective metallic colors that allow the influence of polished brass shine thru the colors 17, translucent hues on brushed gold-tone aluminum that create the faux effects of both selective copper plating and antiquing 18, vivid opaque (non-metallic) colors on formed metal with white coating 19, and solid black plus translucent greys and hues on polished brass to create the impression of selective copper plating and antique 20.

FIG. 3 is a simple generic representation of tools/equipment/machines. Color is generated via simple desktop publishing/office equipment 21 22. Color art of photos, tint, patinas, shading, etc. is designed on a computer with graphics software 21 and printed from a computer printer 22 loaded with sublimation ink cartridges (Previously Sawgrass brand but their patent has expired). The flat (metal) product face must be coated full-face with polyester coating before the color image is transferred. Polyester coating can be sprayed on 24, or applied via other existing processes can be purchased—while intended to be used flat—can be die stamped. Metal stamping dies 23 can be cut and hardened or can be purchased. A Sublimator 25 applies heat to both release color from printed paper and allow color penetration of color in its gaseous state to penetrate the polyester coating. It also applies pressure to aid in the color transfer and to hold the paper and coated metal tightly together, but it does not change the shape of the face of part. Metal stamping presses 26 come in many forms and is represented via conceptual illustration rather than a drawing of an actual press. A metal stamping press 26 applies many lbs of pressure from the hardened metal stamping die to the softer metal part being stamped.

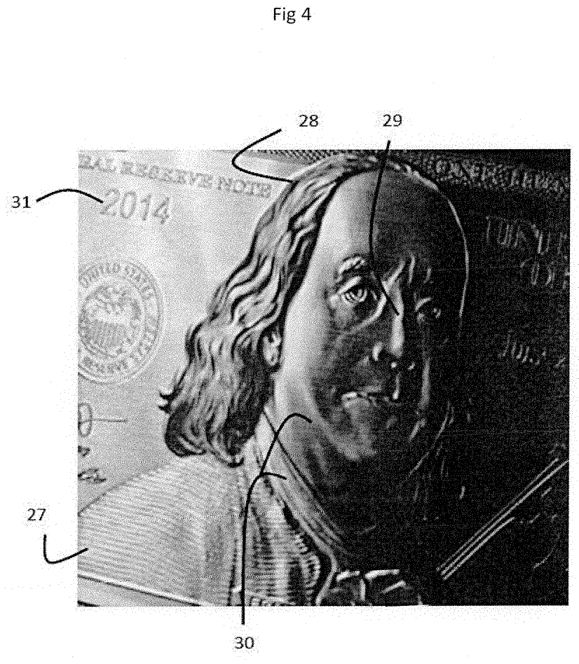

FIG. 4 demonstrates digitally generated colorization features of stamped metal via this process that can be achieved simultaneously with no extra process steps. Finely detailed textures can be selectively stamped into, seen through and enhanced with color 27. Photographic subtlety in color variation, brightness and shading is stretches to conform to shape 28. Depth of stamped relief is visually enhanced by strategically colorizing to allow the metal to reflect more light in high areas and absorb more light in lower areas 29. Metal of one color/alloy—in this case aluminum—can be made to look like multiple other metals—in this case bronze to various degrees throughout the piece without adding layers and without additional setups 30. Colorization details, including but not limited to potential variables such as dates 31, names, years, hair color, paint and clothing color, product color choices, etc. can be changed, added or left out on a piece by piece basis with no mechanical setups. Only alteration/edit of the digital print file is required. Dimensionally stamped features do require a die to be changed.

I claim:

1. A method of enhancing 3d stamped metal surface with color, tint or shading by using the following steps in the following order: sublimation of color into full-face polyester coating on flat faced metal prior to minting/debossing/embossing/stamping versus using other colorizing methods or in spot locations prior to stamping or versus colorizing after forming the metal.

2. This method of claim 1 allows 3 dimensional surfaces the appearance/illusion of plating or tinting without requiring plating processes or mixing tints into lacquers. This includes altering the hue of the metal in selective areas only. Also, the metal finish (polished, brushed, etc.) remains visible.

3. The method of claim 1 makes it possible for stamped, 3 dimensional metal surfaces to have any or all of the following visual features simultaneously within a single layer of coating and with no additional production steps regardless of how many of the visual features below are present:
Metal protection
The look/illusion of plating (full surface or selective areas)
The look/illusion of antiquing or shading to accentuate stamped relief
Spot color or full photographic process color colorization

4. The method of claim 1 can visually represent the colors and surface shapes of non-metal surfaces on metal. (For example, a rough grey rock surface with many subtle shades of green moss growing in some areas can be represented both photographically and dimensionally. Note-this is one of innumerable examples)

5. The method of claim 1 allows colorization and/or the appearance/illusion of antiquing, plating, shading, etc. through the use of color, tinting or shading to be applied with aesthetically pleasing locational precision throughout what will become both raised and recessed areas with no diking, masking or physical (robotic or manual painting or dispensing) application of color. All color is output to flat paper and sublimated to the flat surface of polyester coated metal.)

6. The method of claim 1 means that color is deposited within a continuous full-surface layer of coating to eliminate the individual vulnerabilities of color and patina applied to spots on the surface.

7. The method of claim 1 for colorized, dimensionally stamped products, provides means by which variable color schemes, such as the various stock color choices of a vehicle model, shades of lipstick or clothing color in promotional product settings can be modified digitally, economically and as 1 offs or small batches prior to the sublimation step. (For example, if a new motorcycle model comes in 5 color choices, a dimensional/color metal rendition of each color can be produced simply by digitally printing photos of each color for the sublimation process prior to stamping. Please note that examples are to demonstrate, but not to limit the description of this process benefit.)

8. The method of claim 1 for colorized, dimensionally stamped products, provides means by which variable text (each product produced with its own unique printed text or numbers) can be produced digitally with no physical setups as variable colorized text is generated simply by digitally altering the print image prior to printing the paper used in the sublimation step.

9. The method of claim 1 provides means by which, after creating a product via this invention for colorized, dimensionally stamped products, variable data and images can be added to flat areas via an additional sublimation step with all the efficiency and lack of mess that the sublimation process offers.
